(19) United States
(12) Patent Application Publication
(10) Pub. No.: US 2009/0230644 A1
(43) Pub. Date: Sep. 17, 2009

(54) Utility Cart

(76) Inventor: Edward Stanley, Levittown, PA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/050,033

(22) Filed: Mar. 17, 2008

(51) Int. Cl. B62B 5/00

(52) U.S. Cl. 280/43; 280/638; 280/47.35

(57) ABSTRACT

A utility cart is provided for storing and transporting automotive repair supplies and equipment. The cart can comprise a part compartment, a tool storage compartment, a grease gun compartment, and a handle. The part compartment can define a holding area configured to laterally and vertically support an item disposed therein. The tool storage and grease gun compartments can likewise be configured to receive tools and other items. The cart can be a useful tool not only for facilitating vehicle repair and maintenance, but for other tasks as well.

### BACKGROUND

1. Field of the Invention

The present invention relates generally to a utility cart that can be used to carry and store various tools and equipment necessary for automotive maintenance, and more particularly, to a fuel and/or oil filter cart that facilitates automobile fuel and oil changes.

2. Description of the Related Art

Automotive maintenance is often viewed as a tedious and troublesome undertaking. Given the variety of difficulties and solutions that may exist for a particular problem, many individuals gladly allow trained professionals to maintain their vehicle. However, there are a select few individuals who perform all of their own vehicle maintenance. These people, just as the numerous professionals in the industry, still hope to be efficient and effective in their work. Accordingly, various tools and systems have been developed to help the novice and the professional automotive technicians and mechanics.

Some of the tools that have been developed are commonly found in standard tool kits, such as ratchets, wrenches, sockets, hammers, screw drivers, and other tools. Other important automotive maintenance tools include hydraulic jacks, oil filter wrenches, clamps, torque wrenches, etc. In addition, however, it is very important to keep these tools clean and organized. Tool boxes and other storage containers have been developed to satisfy this need.

### SUMMARY

Despite the various faculties and tools that are at a mechanic's disposal, there is a need for a tool that provides greater ease in performing automotive repairs. Indeed, according to at least one of the embodiments of the inventions disclosed herein is the realization that the prior art is devoid of any equipment that stores, transports, and allows easy access to oil and fuel filters and related tools for performing oil and fuel filter changes.

In accordance with at least one of the embodiments disclosed herein is the realization that the vehicle maintenance work can be greatly facilitated by the use of a mobile tool and part cart. In particular, the cart can be used to transport and store various types of parts and vehicle components during maintenance operations performed by a mechanic. For example, the cart can be used to store one or more fuel filters or oil filters for large trucks, such as semi-trailer trucks, as well as the associated tools required for the maintenance procedure.

Therefore, in at least one of the embodiments disclosed herein, there is provided a mechanic's utility cart comprising a part compartment, a movable divider, a position adjustment mechanism, a tool storage compartment, and a conveyance mechanism. The part compartment can define a holding area configured to laterally and vertically support an item disposed therein. The part compartment can comprise a bottom portion for providing vertical support and at least one side portion for providing lateral support. The movable divider can be attachable within the part compartment to selectively alter the size of the holding area. The movable divider can comprise a support component for laterally supporting an item disposed within the holding area of the part compartment. The movable divider can further comprise an attachment end for removably attaching the divider to one of the bottom and side portions of the part compartment.

The position adjustment mechanism can be disposed at least partially in the part compartment. The position adjustment mechanism can define a plurality of positions to which the movable divider can be adjusted. The position adjustment mechanism can be configured to facilitate selective movability of the divider for altering the size of the holding area. The tool storage compartment can be adjacent to the part compartment and can define an interior area configured to accommodate a tool therein. The conveyance mechanism can be attached to an underside of the cart for facilitating movement of the cart.

In some embodiments, the bottom portion of the part compartment can define a concave surface for supporting the item therein. The position adjustment mechanism can comprise a slotted element disposed on the side portion of the part compartment. The slotted element can be configured to engage the attachment end of the divider for positioning the divider at a given distance from a side of the part compartment. Further, the conveyance mechanism can comprise immobile or movable components. For example, the conveyance mechanism can comprise a low-friction surface that allows the cart to slide easily along a surface. In another example, the conveyance mechanism can comprise a set of wheels attached to the underside of the cart. The wheels can be attached to the cart using height-adjustment brackets configured to lower the center of gravity of the cart. The height-adjustment brackets can have a first section attached to the underside of the cart and a second section attached to the wheel, and the first section can be lower than the second section. The cart can also further comprise a flexible spacer component attached to the side portion of the part compartment for contacting an item disposed therein to center the item within the holding area.

In accordance with another embodiment, a utility cart is provided for storing and transporting automotive repair supplies and equipment. The cart can comprise first and second pairs of part compartments, a tool storage compartment, a grease gun compartment, a handle, and a set of wheels. In such an embodiment, the part compartments of the first pair can be disposed adjacent to each other and the part compartments of the second pair can be disposed adjacent to each other with each part compartment defining a holding area configured to laterally and vertically support an item disposed therein. The part compartments can comprise a bottom portion for providing vertical support and at least one side portion for providing lateral support. The part compartments can further comprise a flexible spacer component attached to the side portion of the part compartment for contacting the item disposed therein to center the item within the holding area.

The tool storage compartment can be disposed intermediate the first and second pairs of part compartments and can define an interior area configured to accommodate a tool therein. The grease gun compartment can extend intermediate the first and second pairs of part compartments and generally parallel to the tool storage compartment. The grease gun compartment can be configured to removably receive a grease gun apparatus therein. The handle can be attached to the cart for facilitating movement thereof. Finally, the set of wheels can be attached to an underside of the cart for facilitating movement of the cart. Each wheel can be positioned equidistant to a respective part compartment to facilitate weight distribution of the cart.

In other embodiments, the bottom portion of the part compartment can define a concave surface for supporting the item therein. The part compartments can comprise a solid-wall structure. Further, the wheels can be attached to the cart using height-adjustment brackets configured to lower the center of gravity of the cart, and the height-adjustment brackets can have a first section attached to the underside of the cart and a second section attached to the wheel, and the first section can be lower than the second section. The part compartments can be cylindrically shaped. In addition, the first pair of part compartments can be configured to receive oil filters and the second pair of part compartments can be configured to receive fuel filters.

In accordance with yet another embodiment, a utility cart is provided for storing and transporting automotive repair supplies and equipment. The cart can comprise first and second compartments, a tool storage compartment, a grease gun compartment, a handle, and a set of wheels. The first and second part compartments can each define a holding area configured to laterally and vertically support an item disposed therein. Each part compartment can comprise a bottom portion for providing vertical support and at least one side portion for providing lateral support. The tool storage compartment can be disposed intermediate the first and second part compartments and define an interior area configured to accommodate a tool therein. The grease gun compartment can extend intermediate the first and second part compartments and generally parallel to the tool storage compartment. The grease gun compartment can be configured to removably receive a grease gun apparatus therein. The handle can be attached to the cart for facilitating movement thereof. The set of wheels can be attached to an underside of the cart for facilitating movement of the cart. Each wheel can be positioned equidistant to a respective part compartment to facilitate weight distribution of the cart.

The cart can also be configured with each part compartment comprising a flexible spacer component attached to the side portion of the part compartment for contacting the item disposed therein to center the item within the holding area. The bottom portion of each part compartment can define a concave surface for supporting the item therein. The wheels can be attached to the cart using height-adjustment brackets configured to lower the center of gravity of the cart. In such an embodiment, the height-adjustment brackets can have a first section attached to the underside of the cart and a second section attached to the wheel, and the first section can be lower than the second section. The part compartments can be cylindrically shaped. The part compartments comprise a solid-wall structure.

### BRIEF DESCRIPTION OF THE DRAWINGS

The above-mentioned and other features of the inventions disclosed herein are described below with reference to the drawings of the preferred embodiments. The illustrated embodiments are intended to illustrate, but not to limit the inventions. The drawings contain the following figures:

FIG. 1 is a perspective view of a utility cart according to an embodiment.

FIG. 2 is a top view of the utility cart shown in FIG. 1, with oil filters and a grease gun being shown in hidden lines.

FIG. 3 is a cross-sectional view of the utility cart taken along line 3-3 in FIG. 2.

FIG. 4 is a perspective view of another embodiment of a utility cart.

FIG. 5 is a top view of the utility cart shown in FIG. 4, with oil filters and a grease gun being shown in hidden lines.

FIG. 6 is a cross-sectional view of the utility cart taken along line 5-5 in FIG. 5.

FIG. 7 is a perspective view of yet another embodiment of a utility cart.

FIG. 8 is a top view of the utility cart shown in FIG. 7.

FIG. 9 is a perspective view of yet another embodiment of a utility cart.

FIG. 10 is a top view of the utility cart shown in FIG. 9.

FIG. 11 is a side view of another embodiment of a utility cart.

FIG. 12 is a side view of yet another embodiment of a utility cart.

FIG. 13A is a side view of another embodiment of a utility cart wherein the cart comprises an embodiment of a stop mechanism in an undeployed position.

FIG. 13B is a side view of the cart of FIG. 13A wherein the stop mechanism is in a deployed position.

FIG. 14A is a side view of yet another embodiment of a utility cart wherein the cart comprises another embodiment of a stop mechanism in an undeployed position.

FIG. 14B is a side view of the cart of FIG. 14A wherein the stop mechanism is in a deployed position.

### DETAILED DESCRIPTION OF THE PREFERRED EMBODIMENTS

While the present description sets forth specific details of various embodiments, it will be appreciated that the description is illustrative only and should not be construed in any way as limiting. Furthermore, various applications of such embodiments and modifications thereto, which may occur to those who are skilled in the art, are also encompassed by the general concepts described herein.

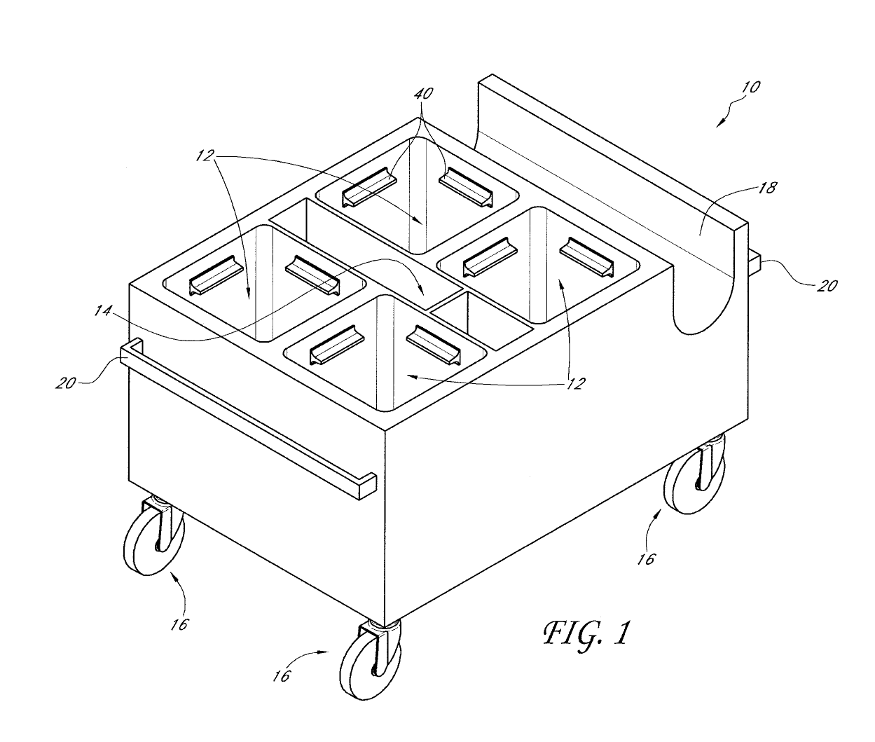

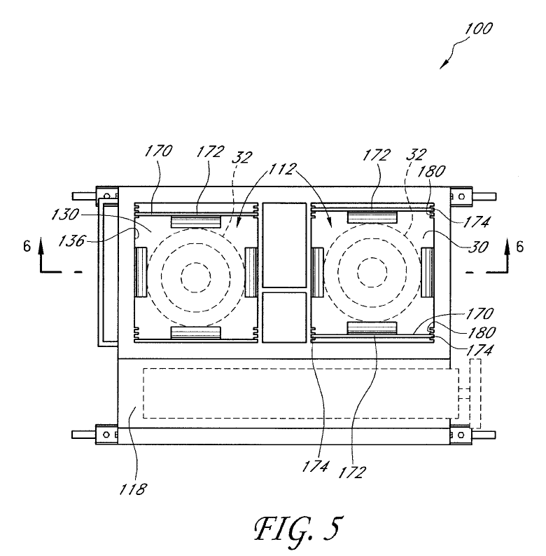

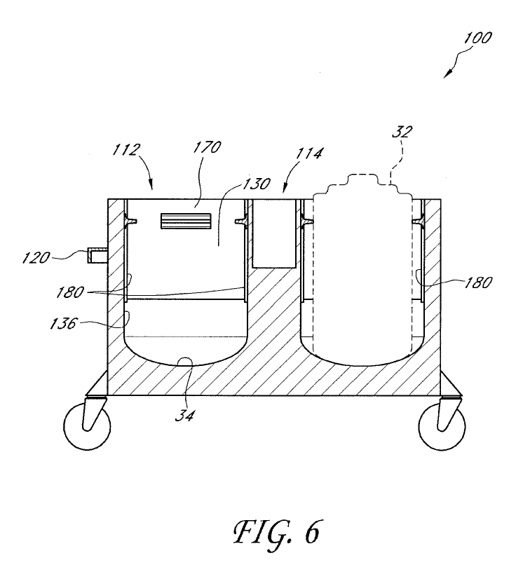

Referring now to the drawings wherein the showings are made for purposes of illustrating preferred embodiments of the present invention, and not for purposes of limiting the same, various embodiments of a utility cart are shown in FIGS. 1-12. The utility cart can be used in a variety of applications. Therefore, although specific uses are mentioned herein, such as for assistance in automotive repair procedures, the utility cart can be used and/or modified to provide valuable aid for a variety of other tasks. In several embodiments, the cart can be used to transport and store various types of parts and vehicle components during maintenance operations performed by a mechanic. For example, the cart can be used to store one or more fuel filters or oil filters for large trucks, such as diesel tractors, as well as the associated tools required for the maintenance procedure.

The cart can include a transport or conveyance mechanism, such as wheels or other means for allowing movement of the cart relative to the ground. In some embodiments, the transport mechanism can be selectively adjustable. For example, when the transport mechanism is wheels, the wheels can be adjustable relative to the cart in order to vary the height of the cart, the distance between the wheels (wheelbase) for improving balance of the cart, and for locking the wheels. Further, a stop mechanism can also be used with the cart in order to maintain the cart in a given position. For example, the stop mechanism can include a lever arm with a distal end that contacts the ground in order to impede rolling movement of the cart. In another embodiment, the stop mechanism can be used to lift the wheels of the cart off the ground, thereby keeping the cart from freely rolling.

FIG. 1 is a perspective view of a utility cart 10 according to a first embodiment. In this embodiment, the utility cart 10 includes four part compartments 12, a tool storage compartment 14, and a conveyance mechanism 16. As shown in the illustrated embodiments, the number of part compartments can be varied as necessary for a given application. It is contemplated that in some uses, such as when an old item is replaced with a new item (such as in an oil filter change), the number of part compartments should be adjusted to provide an extra or empty compartment so that when the old item is replaced, there is an available space in the cart for the old item. For example, during an oil change, the expired oil filter can be removed and placed into an empty part compartment. A new oil filter can be removed from another part compartment of the cart, thus leaving creating another empty part compartment. Accordingly, if multiple oil filter changes are performed consecutively, there can be empty part compartments in the cart to receive the expired filters.

Additionally, the cart 10 includes a grease gun compartment 18. Furthermore, the cart can include one or more handles 20. Although this embodiment is shown as being generally rectangular and boxy, it is contemplated that the shape of the cart 10 can be modified to be more streamlined, include curved edges, or stylistic variations.

Further, it is contemplated that although the cart 10 is shown as having solid walls and compartments, cart 10 can be formed using a mesh or wire construction. As such, the contents of the compartments can be visible from any angle, thus eliminating guesswork. Further, in such an embodiment, the cart 10 can be configured to allow fluids to pass therethrough, for example, to facilitate washing of the cart 10. However, it is contemplated that depending on the use, the part compartments 12 of the cart 10 can include reservoirs for collecting fluids, small components, or other materials and maintaining them within the part compartment 12.

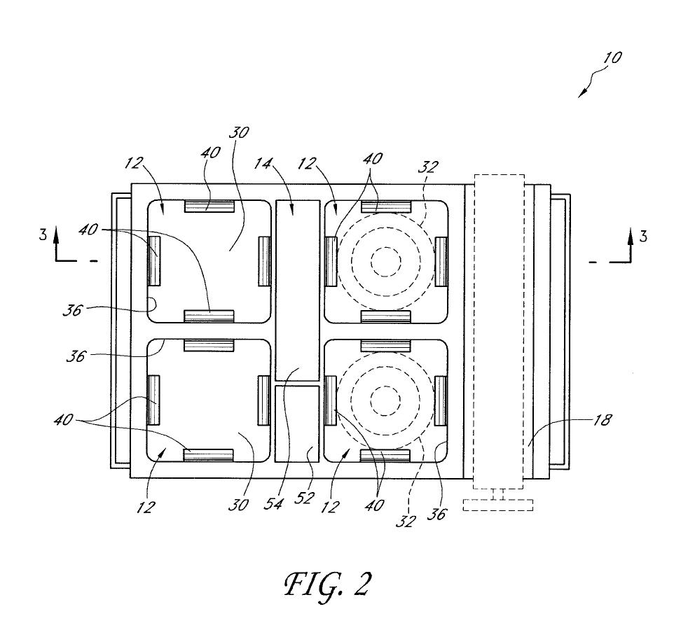

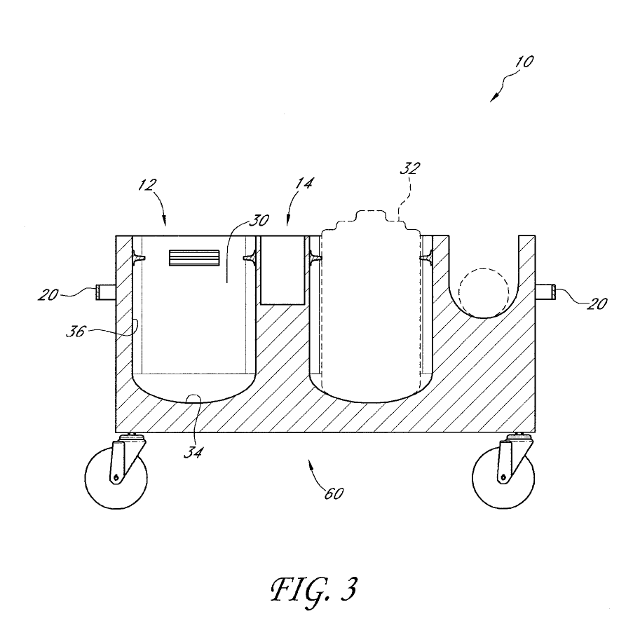

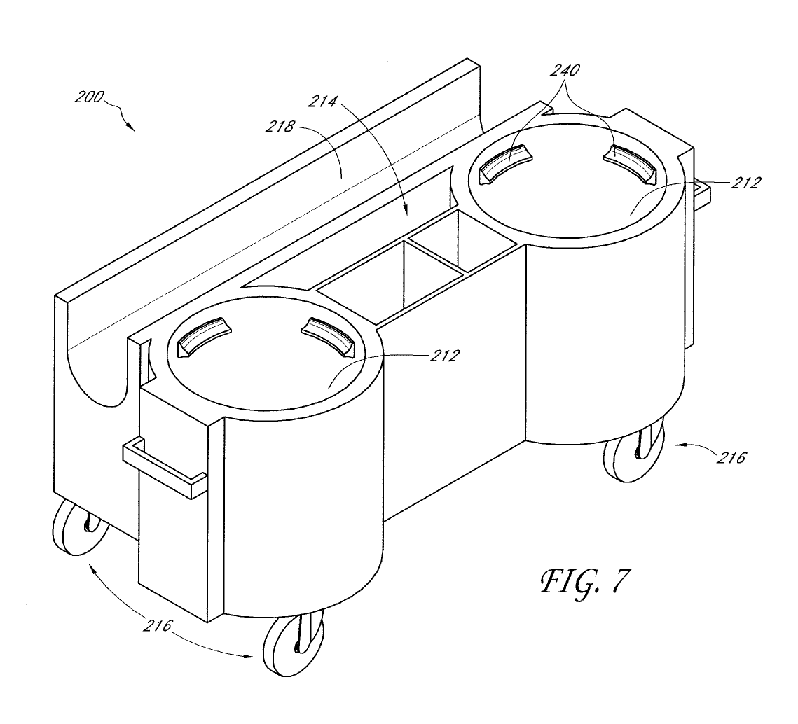

Referring now to FIG. 2, the part compartment 12 can define a holding area 30 configured to laterally and vertically support an item disposed therein. As illustrated in FIG. 2, such an item 32 can be a fuel or oil filter (shown in hidden lines). It should be noted that although the item 32 is illustrated as a filter, the item 32 can be any variety of components, replacement parts, or other objects used in the procedure, whether automobile related or not. As shown in FIG. 3, the part compartment 12 can comprise a bottom portion 34 for providing vertical support and at least one side portion 36 for providing lateral support. The first embodiment of the cart 10 is configured with each part compartment 12 having a generally square cross-section. However, as illustrated in FIGS. 7-10, the part compartment 12 can also be configured to be generally cylindrical. Other shapes and geometries can be incorporated into the design and configuration of the cart and part compartments.

It should be noted that the embodiments of the cart disclosed herein may be particularly beneficial in certain application in which the supported items need to maintain an upright orientation. For example, as shown in FIG. 2, oil filters can be supported in an upright configuration in order to prevent spilling of oil. This is particularly advantageous due to the fact that in some procedures, a new filter may be primed with new oil and placed upright to avoid spillage. Further, expired filters may be removed and also placed into the cart and maintained upright to avoid spillage.

The bottom portion 34 can provide vertical support to the item 32. In order to accomplish this, at least a portion of the bottom portion 34 can contact the item 32 disposed therein. For example, the part compartment 12 can be configured with the bottom portion 34 thereof being generally flat. However, as shown in side cross-sectional view of FIG. 3, the bottom portion 34 can be generally hemispherical to facilitate nesting of the item in a centralized location of the part compartment 12. In other embodiments, the bottom portion 34 can be generally conical. Further, the bottom portion 34 can also be an inverted cone, hemisphere, pin or other such element so as to make contact with an item, such as the oil filter 32, at a single point. This feature may be valuable to allow parts to sit above undesirable fluids or materials that may enter the part compartment 12 or may allow the item 32 to drain such a fluid.

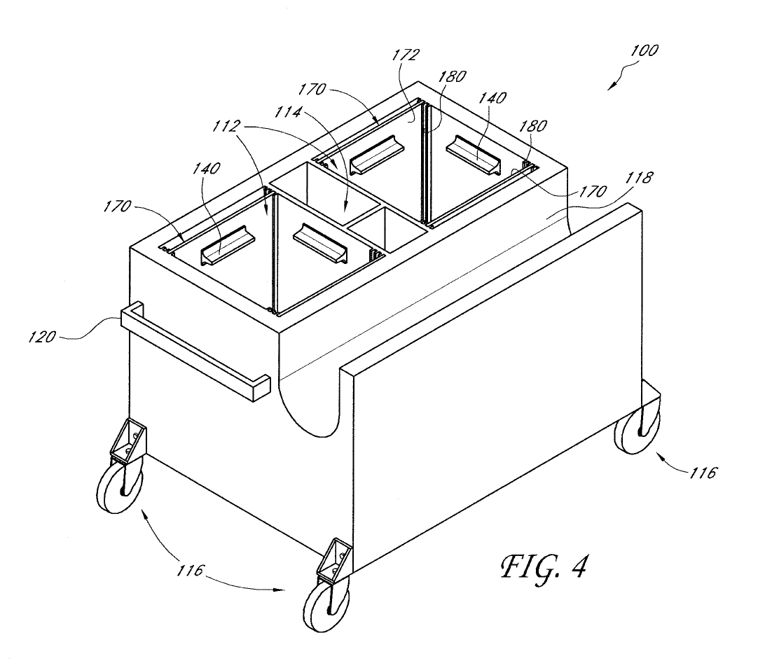

The side portion 36 of the part compartment 12 can be used to provide direct or indirect lateral support to the item 32 as required. In some embodiments, such as that shown in FIGS. 1-3, the side portion 36 generally defines the boundary of the holding area 30 of the part compartment 12. Thus, the available interior volume of the holding area 30 can be set by the configuration and position of the side portion 36. In other embodiments, such as that illustrated in FIGS. 4-6, the cart can comprise other components that can be used to alter the shape and boundaries of the part compartment by attaching to one of the bottom and side portions thereof, as described further below.

Referring still to FIGS. 2-3, the side portion 36 can be configured as a flat surface that generally extends about the holding area 30. The side portion 36 can extend about substantially all of the holding area 30 or at least a portion thereof. The side portion 36 can comprise one or more faces of an interior compartment surface. The side portion 36 can also extend about only a portion of the holding area 30. For example, the side portion 36 can be discontinuous and provide support to certain portions of the item 32 to ensure that the item is laterally supported. Such an embodiment is possible, for example, where the cart is fabricated using a wire construction. Therefore, although the embodiment of FIGS. 1-3 illustrates continuous side portions 36, the side portions 36 can be variously formed and configured as desired.

FIGS. 1-3 also illustrate that the part compartments 12 can include a spacer component 40 for contacting the item 32 disposed therein to center the item 32 within the holding area 30. The spacer component 40 can be attached to the side portion 36 of the part compartment 12. The spacer component 40 can comprise one or more components and can extend continuously or discontinuously about the inner periphery of the holding area 30. Further, the spacer component 40 can be removably attached to the part compartment 12.

The spacer component 40 can be fabricated from a flexible material, such as rubber or plastic. The spacer component 40 can allow the part compartment 12 to receive items of various sizes. For example, the part compartment 12 can include one or more spacer components 40 of various lengths, widths, and heights that are positioned at any given orientation or height within the part compartment 12. In this manner, the spacer component 40 can allow the part compartment 12 to accommodate a wide range of item sizes. As illustrated, the spacer component 40 preferably contacts an item 32 disposed in the part compartment 12 sufficiently thereabout to provide lateral support to the item 32. Thus, it is contemplated that the item 32 may be securely received within the part compartment 12.

As also shown in the embodiment of FIGS. 1-3, the cart 10 can also be configured to include the tool storage compartment 14. The tool storage compartment 14 of the cart 10 is positioned intermediate the part compartments 12. The tool storage compartment 14 can include one or more discrete sections 52, 54 which can each define an interior area configured to accommodate a tool or part(s) therein. In other embodiments, the tool storage compartment 14 can include a single section defining an interior area configured to accommodate a tool or part(s) therein. The tool storage compartment 14 can include any variety of partitions, receptacles, hooks, or other tool-specific features that further facilitate the storage or placement of a tool or part(s) therein.

Finally, the handles 20 can be attached to the cart 10 at either or both ends thereof. The handles 20 can be integrally or separately formed from the cart 10 and can be of any configuration. For example, in the cross-sectional view of FIG. 3, it is shown that the handles provide a gripping section on an underside of the handle 20. The handles 20 can also be pull-bars or otherwise.

The conveyance mechanism 16 of the cart 10 preferably facilitates free and easy movement of the cart 10 to a desired location. However, the conveyance mechanism 16 can also include a brake or stop element that maintains the cart 10 in a specific position, to keep the cart 10 from moving when it is maneuvered to an appropriate location. The conveyance mechanism 16 can comprise immobile or movable components. For example, the conveyance mechanism 16 can comprise a low-friction surface that allows the cart 10 to slide along a surface. In the illustrated embodiments, the conveyance mechanism 16 is illustrated as a set of wheels, such as casters. Nevertheless other mechanisms can be used to provide maneuverability to the cart 10, as would be apparent to one of skill in the art.

The conveyance mechanism 16 can be attached to an underside 60 of the cart 10 for facilitating movement of the cart 10. In some embodiments, the conveyance mechanism 16 can be integrated into the cart 10 or removed therefrom entirely. Furthermore, the conveyance mechanism 16 can be removably attachable to the cart 10. For example, the cart 10 can be set or placed on the conveyance mechanism 16 and maneuvered as desired, and subsequently removed from or off of the conveyance mechanism 16.

Further, the conveyance mechanism can comprise a set of wheels attached to the underside of the cart. The wheels can be attached to the cart using height-adjustment brackets configured to lower the center of gravity of the cart. The height-adjustment brackets can have a first section attached to the underside of the cart and a second section attached to the wheel, and the first section can be lower than the second section. The cart can also further comprise a flexible spacer component attached to the side portion of the part compartment for contacting an item disposed therein to center the item within the holding area.

In some embodiments, the conveyance mechanism can be selectively adjustable. For example, when the conveyance mechanism comprises wheels, the wheels can be adjustable relative to the cart in order to vary the height of the cart. Further, the conveyance mechanism can be configured to vary the distance between the wheels (wheelbase) for improving balance of the cart. Additionally, the conveyance mechanism can include a locking element that enables the conveyance mechanism to be locked or movement of the cart to be impeded. For example, the locking element can provide for adjustment of the rotation speed of wheels of the cart or provide a wheel lock that stops rotation of wheels.

Additionally, the embodiment illustrated in FIGS. 1-3 also illustrates that other compartments or features can be incorporated into the design of the cart 10. For example, in the mechanic's embodiment shown in these figures, the cart 10 can include the grease gun compartment 18. The grease gun compartment 18 can be positioned at an end of the cart 10, as shown in FIGS. 1-3. However, the grease gun compartment 18 can also be positioned intermediate the part compartments 12, adjacent the tool compartment 14. The configuration of the cart can be modified to move the grease gun compartment 18 and tool compartment 14 relative to the part compartments 12 as desired. In some embodiments, the center of gravity can be selectively controlled by repositioning or modifying the location of the various compartments. Finally, it is contemplated that other compartments may be used and incorporated into the design. As indicated above, although the illustrated embodiments are discussed in the context of automotive repair and maintenance, the compartments can be used to hold other components or tools. Thus, the embodiments discussed herein should not be construed as limiting.

FIGS. 4-6 illustrate another embodiment of a utility cart 100. In this embodiment, the cart 100 includes a pair of part compartments 112. The cart also comprises a tool storage compartment 114, a set of wheels 116, a grease gun compartment 120, and a handle 120. This embodiment is similar to that shown in FIGS. 1-3 except for the inclusion of only two part compartments 112 and the orientation of the grease gun compartment 120 relative to the other compartments of the cart 100. Further, in this embodiment of the cart 120, the size and configuration of the part compartment is adjustable, as discussed below.

As noted, there are several common features between the embodiments of FIGS. 1-3 and of FIGS. 4-6, such as a holding area 130, bottom and side portions 134, 136 of the part compartments 112, the wheels 116, and the use of a spacer component 140. The discussion of such disclosure as made above is reiterated with respect to the embodiment of FIGS. 4-6 and will not be repeated at this point. However, it should be noted that the embodiment of FIGS. 4-6 includes additional features that can be incorporated into an embodiment of the cart, and can even be used in connection with other embodiments of the cart. For that matter, it is contemplated that any of the individual features disclosed with respect to any of the embodiments shown and discussed herein can equally be incorporated into another embodiment, as desired.

Referring again to FIGS. 4-6, the cart 100 can comprise a movable divider 170 that can be attachable within the part compartment 112 to selectively alter the size of the holding area 130. The movable divider 170 can be movable relative to a side of the cart 100. In some embodiments, the movable divider 170 can be moved or translated such that it remains oriented generally parallel to the side of the cart 100. However, in other embodiments, the movable divider can pivot horizontally or vertically, fold along its width or length, or otherwise deform in order to cause at least a portion thereof to be disposed away from the inner periphery of the holding area 130 to thereby contact or provide greater support for an item 32 disposed therein.

In some embodiments, such as that shown in FIGS. 4-6, the movable divider 170 can comprise a support component 172 for laterally supporting an item 32 disposed within the holding area 130 of the part compartment 112. The support component 172 can be an edge, ridge, a section, or the entire body of the movable divider 170. Additionally, the movable divider 170 can comprise an attachment end 174 for removably attaching the divider 170 to one of the bottom and side portions 134, 136 of the part compartment 112. As illustrated, the divider 170 comprises two opposing attachment ends 174 that can attach to within the part compartment 112 to secure the divider 170 at a selected position.

In addition, the cart 100 can comprise a position adjustment mechanism 180. The position adjustment mechanism 180 can be disposed at least partially in the part compartment 112. The position adjustment mechanism 180 can define a plurality of positions to which the movable divider 170 can be adjusted. The position adjustment mechanism 180 can be configured to facilitate selective movability of the divider 170 for altering the size of the holding area 130. For example, the position adjustment mechanism 180 can facilitate the rotation or translation of the divider 170. As illustrated in FIGS. 4-6, the position adjustment mechanism 180 can be configured as a set of vertically arranged slots into which the opposing ends 174 of the divider 170 can be inserted. As such, the dimensions of the holding area 130 can be modified as required to securely fit an item 32 therein.

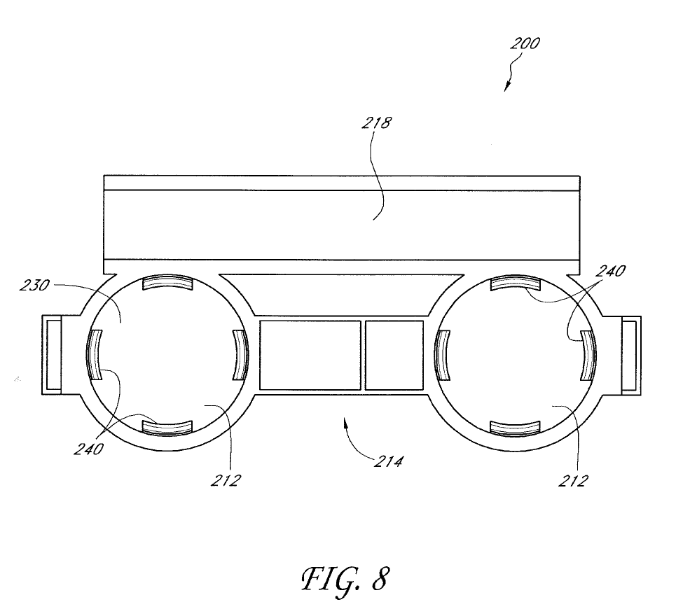

Referring now to FIGS. 7-8, another embodiment of a utility cart 200 is illustrated. The cart 200 can be configured to include a pair of cylindrically-shaped part compartments 212, as well as a tool compartment 214 with various sections, a conveyance mechanism 216, a grease gun compartment 218, holding area 230, side and bottom portions, and spacer component 240, etc. As similarly noted above with respect to FIGS. 4-6, the descriptions of the features mentioned above with respect to FIGS. 1-6 is reiterated with respect to the cart 200 shown in FIGS. 7-8 and will not be repeated. Each of these features and the description thereof can be incorporated with into the cart 200 shown in FIGS. 7-8.

The cart 200 shown in FIGS. 7-8 uniquely employs cylindrical part compartments 212 that can receive cylindrical items within a particular size range. Although the part compartments 212 can be adjustable in some embodiments, the cart 200 shown in FIGS. 7-8 uses discretely sized part compartments 212 to accommodate a targeted size of parts or items. As such, it is contemplated that the size of the part compartments 212 can be made to certain small, medium, or large sizes, such as according to vehicle oil filter sizes. Additionally, the size of a respective part compartment 212 can be different that the other part compartment 212 of the same cart 200. As such, the cart 200 can provide options for usage and size compatibility.

Furthermore, the tool compartment 218 of the cart 200 can be uniquely configured to take advantage of the space between the cylindrically-shaped part compartments 212. Thus, the tool compartment 218 can comprise one or more individual sections that can be configured to receive or support various parts or components.

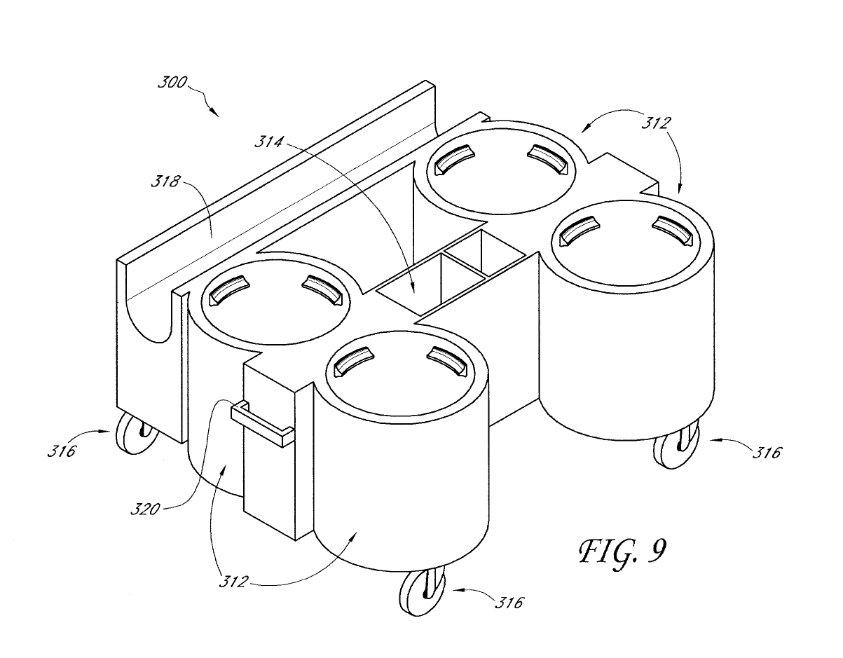

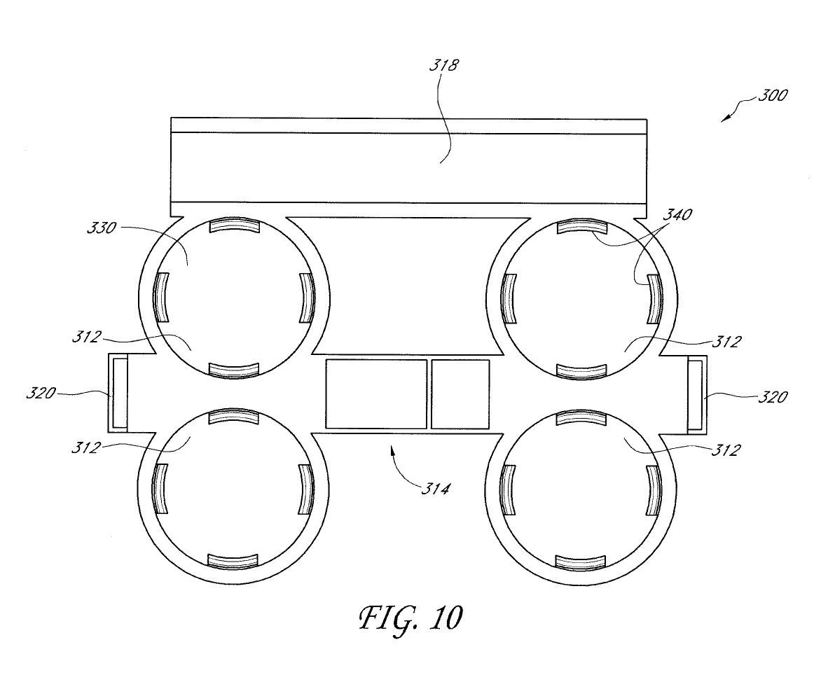

Referring now to FIGS. 9-10, another embodiment of a utility cart 300 is illustrated. The cart 300 can be configured to include opposing pairs of cylindrically-shaped part compartments 312, as well as a tool compartment 314 with various sections, a conveyance mechanism 316, a grease gun compartment 318, holding area 330, side and bottom portions, and spacer component 340, etc. As similarly noted above with respect to FIGS. 7-8, the descriptions of the features mentioned above with respect to FIGS. 1-8 is reiterated with respect to the cart 300 shown in FIGS. 9-10 and will not be repeated. Each of these features and the description thereof can be incorporated with the cart 300 shown in FIGS. 9-10.

Similar to the embodiment of the cart 200 shown in FIGS. 7-8, the cart 300 shown in FIGS. 9-10 also employs cylindrical part compartments 312 that can receive cylindrical items within a particular size range. As noted with respect to the embodiment in FIGS. 7-8, the part compartments 312 can be configured to accommodate items of distinct sizes and shapes. The cart 300 includes four part compartments 312 and therefore may be beneficial for individuals needing storage of more than one item at a time. For example, if performing a fuel and/or oil filter change on a semi-trailer truck, a mechanic could need two fuel filters and two oil filters at a time because these types of trucks often use primary, secondary, full-flow, or bypass filters. Accordingly, the cart 300 could be of benefit to such mechanics because it reduces the number of loose parts, aids in organization and creates a discrete set of parts and tools that are needed for a given maintenance procedure.

Referring now to FIGS. 11-12, additional embodiments of the cart are shown. FIG. 11 is a side view of a cart 400 having at least one part compartment 412, a grease gun compartment 418, and can include any of the other features discussed above with respect to the embodiments illustrated in FIGS. 1-10. Likewise, a side view of a cart 500 is illustrated in FIG. 12. In contrast to the cart 400 of FIG. 11, the cart 500 of FIG. 12 includes at least two part compartments 512, a tool compartment 514, and a grease gun compartment 518. Further, the carts 400 and 500 also illustrate a unique conveyance mechanism 416, 516 comprising a set of wheels 430, 530 attached to the underside of the carts 416, 516. The conveyance mechanisms 416, 516 can also comprise height-adjustment brackets 440, 540 configured to lower the center of gravity of the cart 416, 516. As noted above, the conveyance mechanism can also be configured to allow for variable and selective adjustment of the height, wheelbase, or rotation speed/wheel lock capability.

The height-adjustment brackets 440, 540 can have a first section 442, 542 attached to the underside of the cart 416, 516 and a second section 444, 544 attached to the wheel 430, 530. The height-adjustment brackets 440, 540 can be formed from a continuous piece of material. However, it is also contemplated that the height-adjustment brackets 440, 540 can be formed using various parts. Further, in some embodiments, the height-adjustment brackets 440, 540 can be configured, as shown in FIGS. 11-12, such that the first section 442, 542 is lower than the second section 444, 544. Thus, the center of gravity of the cart 400, 500 can be lowered, making the cart 400, 500 more stable and less likely to tip over.

The wheels 430, 530 and/or the height-adjustment brackets 440, 540 can be partially or fully integrated with the design of the cart 400, 500. For example, a body of the cart 400, 500 may be designed such that the wheel 430, 530 are disposed at least partially underneath a respective part compartment, tool compartment, or grease gun compartment. As noted above, the dimension and arrangement of the compartments can be modified in various configurations. The embodiments illustrated in FIGS. 1-12 provide illustrative examples of potential configurations. However, it is contemplated that in such configurations, the conveyance mechanism, when present, can ensure that the cart is stable and secure.

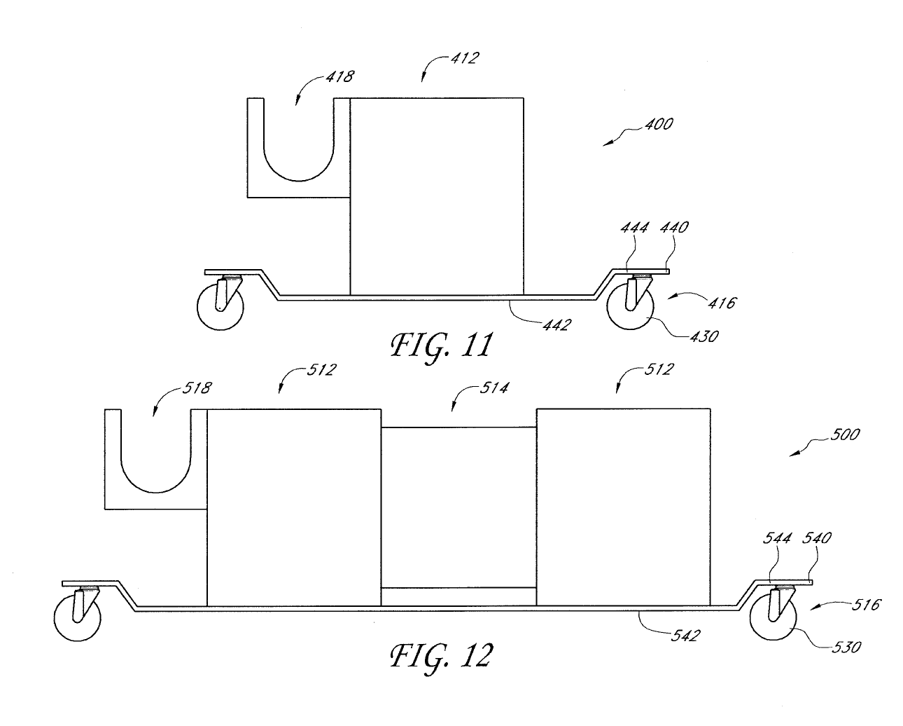

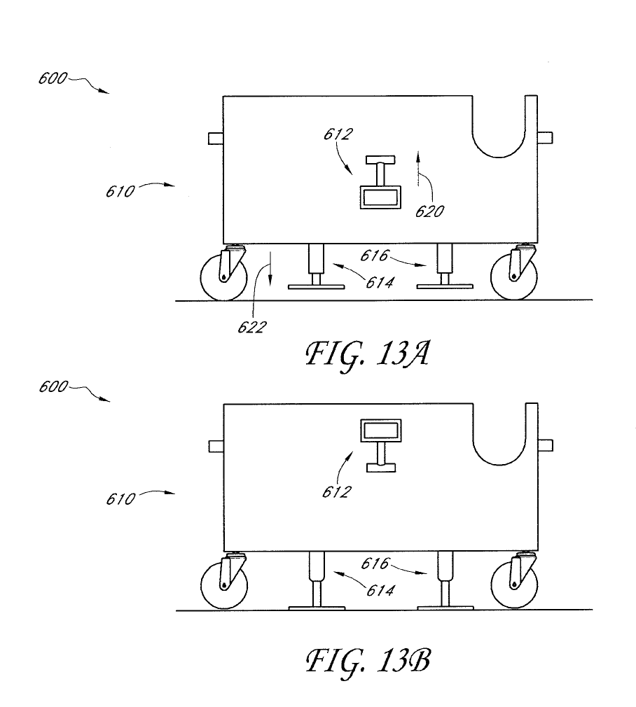

Referring now to FIGS. 13A-B and 14A-B, two exemplary embodiments of a stop mechanism are illustrated. In FIG. 13A-B, a utility cart 600 comprises a stop mechanism 610. In this embodiment, the stop mechanism 610 can comprise a switch arm 612 and first and second actuation bases 614, 616. As illustrated in FIG. 13A, when in an undeployed position, the switch arm 612 can be oriented at a downward angle relative to the cart 600 and the first and second actuation bases 614, 616 can be retracted and off of the ground at a given distance.

FIG. 13B illustrates the deployed position of the stop mechanism 610. As illustrated, the switch arm 612 has been rotated upwardly as shown by the arrow 620 in FIG. 13A. Upon such rotation of the switch arm 612, the first and second actuation bases 614, 616 can be deployed and move from the retracted or stowed position to the deployed position as shown by the arrow 622. In some embodiments, the first and second actuation bases 614, 616 can lift the cart 600 off of the ground such that the cart 600 is suspended in the air by the stop mechanism 610. However, it is contemplated that the stop mechanism 610 can also be configured to contact the ground to substantially impeded movement of the cart 600.

Furthermore, although first and second actuation bases 614, 616 are shown, it is contemplated that a single actuation base may also be used. In this regard, the actuation base can be configured to define any variety of useful shapes that facilitates reliable contact with the ground to thereby restrict or eliminate movement of the cart. In addition, it is contemplated that the actuation base can comprise a material that frictionally engages the ground and tends not to slide against the ground. For example, a material such as rubber can be used that exhibits tacky or resilient qualities. Such materials are known in the art.

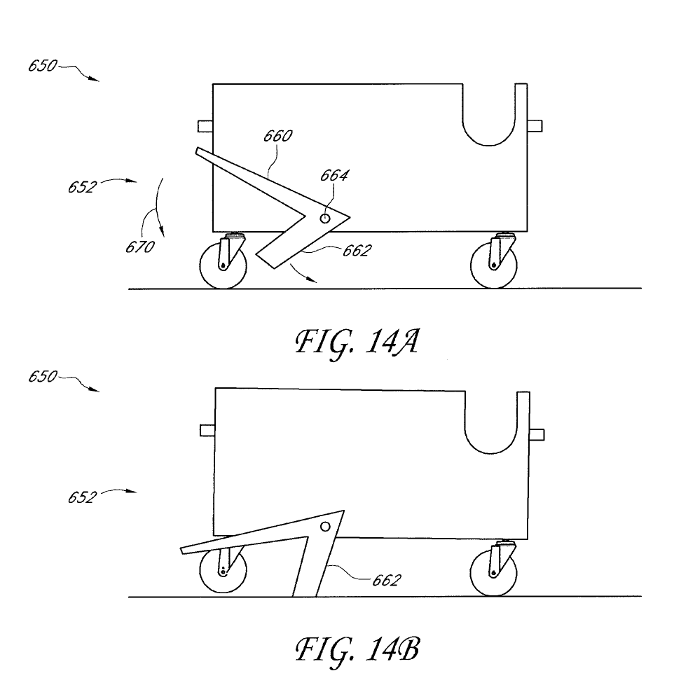

Referring now to FIG. 14A, another embodiment of a cart 650 is illustrated. The cart 650 can comprise a stop mechanism or lever arm 652 that comprises a handle 660 and a prop device 662 that can pivot about a pivot point 664. As shown in FIGS. 14A-B, the lever arm 652 can allow a user to engage the prop device 662 of the lever arm 652 the ground, and in some embodiments, can cause the prop device 662 to prop up one or more wheels. In use, the handle 660 can be rotated downwardly as shown by the arrow 670. As the handle 660 is moved downwardly, the prop device 662 also rotates downwardly until contacting the ground.

It is contemplated that the lever arm 652 can be formed as a monolithic piece or formed of individual parts that are assembled together. Preferably, the lever arm 652 is configured such that any rotation imparted to the handle 660 is likewise transmitted to the prop device 662. Furthermore, the lever arm 652 can be disposed on a single side of the cart 650. However, it is contemplated that the lever arm 652 can comprise dual segments that are disposed on both sides of the cart 650. In such an embodiment, the handle 660 can span the width of the cart 650 and interconnect the dual segments. Thus, two prop devices can contact the ground on both sides of the cart 650.

Accordingly, the stop mechanisms disclosed above can be used to restrict or prohibit movement of the cart. The stop mechanisms disclosed above and illustrated in the accompanying figures are exemplary embodiments, and it is contemplated that other features can be incorporated into the stop mechanisms by one of skill in the art.

Furthermore, although the conveyance mechanism in some embodiments has been illustrated as using four wheels, it is contemplated that more or less wheels can be used. Wheels can also be substituted for other mechanisms, and movement of the cart can be omni-directional, directional, or otherwise. Furthermore, each wheel can be positioned equidistant to a respective part compartment to facilitate weight distribution of the cart.

Accordingly, various arrangements can be configured and prepared using many of the embodiments discussed herein. Yet other embodiments and arrangements are also contemplated provided the present disclosure. The advantages and benefits of the embodiments disclosed herein include improved mobility and organization of parts for various maintenance procedures, enhanced cleanliness of the workspace due to such organization, and ready access to parts when needed. As noted above, one of the potential uses of embodiments of the utility cart includes holding preloaded or primed oil or fuel filters that need to be held upright to avoid spilling of the oil or fuel in the filter. Through the use of the novel and innovative embodiments disclosed herein, a mechanic is able to maintain these filters in an upright orientation and place used filters in the cart in an upright orientation to avoid spillage of the oil or fuel in the used filters. This innovative cart satisfies a distinct need in the market and provides an extremely helpful tool for mechanics in particular.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while several variations of the invention have been shown and described in detail, other modifications, which are within the scope of the invention, will be readily apparent to those of skill in the art based upon this disclosure. It is also contemplated that various combination or sub-combinations of the specific features and aspects of the embodiments may be made and still fall within the scope of the invention. It should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

What is claimed is:

1. A mechanic's utility cart comprising:
a part compartment defining a holding area, the holding area being configured to laterally and vertically support an item disposed therein, the part compartment comprising a bottom portion for providing vertical support and at least one side portion for providing lateral support;
a movable divider being attachable within the part compartment to selectively alter the size of the holding area, the movable divider comprising a support component for laterally supporting an item disposed within the holding area of the part compartment, the movable divider further comprising an attachment end for removably attaching the divider to one of the bottom and side portions of the part compartment;
a position adjustment mechanism disposed at least partially in the part compartment, the position adjustment mechanism defining a plurality of positions to which the movable divider can be adjusted, the position adjustment mechanism being configured to facilitate selective movability of the divider for altering the size of the holding area;
a tool storage compartment adjacent to the part compartment, the tool storage compartment defining an interior area configured to accommodate a tool therein; and
a conveyance mechanism attached to an underside of the cart for facilitating movement of the cart.

2. The cart of claim 1, wherein the bottom portion of the part compartment defines a concave surface for supporting the item therein.

3. The cart of claim 1, wherein the position adjustment mechanism comprises a slotted element disposed on the side portion of the part compartment, the slotted element being configured to engage the attachment end of the divider for positioning the divider at a given distance from a side of the part compartment.

4. The cart of claim 1, wherein the conveyance mechanism comprises a set of wheels attached to the underside of the cart.

5. The cart of claim 4, wherein the wheels are attached to the cart using height-adjustment brackets configured to lower the center of gravity of the cart, the height-adjustment brackets having a first section attached to the underside of the cart and a second section attached to the wheel, wherein the first section is lower than the second section.

6. The cart of claim 1, further comprising a flexible spacer component attached to the side portion of the part compartment for contacting an item disposed therein to center the item within the holding area.

7. The cart of claim 1, further comprising a stop mechanism.

8. A utility cart for storing and transporting automotive repair supplies and equipment, the cart comprising:
first and second pairs of part compartments, the part compartments of the first pair being disposed adjacent to each other and the part compartments of the second pair being disposed adjacent to each other, each part compartment defining a holding area configured to laterally and vertically support an item disposed therein, the part compartment comprising a bottom portion for providing vertical support and at least one side portion for providing lateral support, the part compartment further comprising a flexible spacer component attached to the side portion of the part compartment for contacting the item disposed therein to center the item within the holding area;
a tool storage compartment disposed intermediate the first and second pairs of part compartments, the tool storage compartment defining an interior area configured to accommodate a tool therein;
a grease gun compartment extending intermediate the first and second pairs of part compartments and generally parallel to the tool storage compartment, the grease gun compartment being configured to removably receive a grease gun apparatus therein;
a handle attached to the cart for facilitating movement thereof; and
a set of wheels attached to an underside of the cart for facilitating movement of the cart, each wheel being positioned equidistant to a respective part compartment to facilitate weight distribution of the cart.

9. The cart of claim 8, wherein the bottom portion of the part compartment defines a concave surface for supporting the item therein.

10. The cart of claim 8, wherein the part compartments comprise a solid-wall structure.

11. The cart of claim 8, wherein the wheels are attached to the cart using height-adjustment brackets configured to lower the center of gravity of the cart, the height-adjustment brackets having a first section attached to the underside of the cart and a second section attached to the wheel, wherein the first section is lower than the second section.

12. The cart of claim 8, wherein the part compartments are cylindrically shaped.

13. The cart of claim 8, wherein the first pair of part compartments are configured to receive oil filters and the second pair of part compartments are configured to receive fuel filters.

14. A utility cart for storing and transporting automotive repair supplies and equipment, the cart comprising:
first and second part compartments each defining a holding area configured to laterally and vertically support an item disposed therein, each part compartment comprising a bottom portion for providing vertical support and at least one side portion for providing lateral support;
a tool storage compartment disposed intermediate the first and second part compartments, the tool storage compartment defining an interior area configured to accommodate a tool therein;
a grease gun compartment extending intermediate the first and second part compartments and generally parallel to the tool storage compartment, the grease gun compartment being configured to removably receive a grease gun apparatus therein;
a handle attached to the cart for facilitating movement thereof; and
a set of wheels attached to an underside of the cart for facilitating movement of the cart, each wheel being positioned equidistant to a respective part compartment to facilitate weight distribution of the cart.

15. The cart of claim 14, wherein each part compartment further comprises a flexible spacer component attached to the side portion of the part compartment for contacting the item disposed therein to center the item within the holding area.

16. The cart of claim 14, wherein the bottom portion of each part compartment defines a concave surface for supporting the item therein.

17. The cart of claim 14, wherein the wheels are attached to the cart using height-adjustment brackets configured to lower the center of gravity of the cart, the height-adjustment brackets having a first section attached to the underside of the cart and a second section attached to the wheel, wherein the first section is lower than the second section.

18. The cart of claim 14, wherein the part compartments are cylindrically shaped.

19. The cart of claim 14, wherein the part compartments comprise a solid-wall structure.

20. The cart of claim 14, further comprising a stop mechanism.
